(19) United States
(12) Patent Application Publication
(10) Pub. No.: US 2008/0127441 A1
(43) Pub. Date: Jun. 5, 2008

(54) VEHICLE WIPER AND WIPER BLADE

(76) Inventor: Shigekane Inoue, Kosai-shi (JP)

Correspondence Address: Pearl Cohen Zedek Latzer, LLP, 1500 Broadway, 12th Floor, New York, NY, 10036, US

(21) Appl. No.: 11/943,898

(22) Filed: Nov. 21, 2007

(30) Foreign Application Priority Data
Nov. 30, 2006 (JP) 2006-324633

(51) Int. Cl. B60S 1/52

(52) U.S. Cl. 15/250.04

(57) ABSTRACT

A wiper blade pivots in an open wiping direction and a close wiping direction opposite to the open wiping direction, thereby wiping a target surface to be wiped. The target surface has a lateral end. When moving in the open wiping direction, the wiper blade approaches the lateral end. The wiper blade defines a blade axis. A washer nozzle is arranged offset from the blade axis in the open wiping direction. An eccentric line extends parallel with the blade axis and passes through an ejection hole. The ejecting direction of washer fluid ejected from the ejection hole is set toward the blade axis with respect to the eccentric line.

### BACKGROUND OF THE INVENTION

The present invention relates to a vehicle wiper and a wiper blade each including a washer nozzle that ejects washer fluid onto a target surface to be wiped.

To clean a dry windshield with dirt, for example, on a sunny day, a washer device ejects washer fluid onto the windshield before a wiper blade wipes a target surface of the windshield, which is to be wiped. To reliably apply the washer fluid onto the target surface, Japanese Laid-Open Utility Model Publication No. 50-104333 discloses a washer nozzle (referred to as a washer fluid ejection pipe in the document) that is mounted in a wiper blade so that washer fluid is ejected onto a target surface at close range.

A wiper blade pivots between a lower reverse position and an upper reverse position to wipe a target surface. When located at the lower reverse position, the wiper blade extends substantially parallel with a lateral direction of the vehicle at a position corresponding to the lower end of the windshield. When arranged at the upper reverse position, the wiper blade extends substantially perpendicular to the lateral direction of the vehicle. The wiper blade described in Japanese Laid-Open Utility Model Publication No. 50-104333 includes a plurality of washer nozzles, which are arranged at both sides with respect to the center line of the wiper blade.

If the upper reverse position of the wiper is set at a lateral end of the windshield, or in the vicinity of a front pillar, which is an “A-pillar” of the vehicle, overspray may occur. Specifically, overspray refers to splash of some of the washer fluid ejected by a washer nozzle out of the lateral end of the windshield toward the exterior, which may be caused by relative wind. Such overspray wastes the washer fluid and may be splashed on a pedestrian nearby. Particularly, when the wiper blade rises from the lower reverse position toward the upper reverse position, the washer fluid, which is ejected onto the wiping path of the wiper blade prior to the wiping of the wiper blade, may easily cause overspray.

### SUMMARY OF THE INVENTION

Accordingly, it is an objective of the present invention to provide a vehicle wiper and a wiper blade that suppress overspray of washer fluid.

According to one aspect of the invention, a vehicle wiper secured to a pivot shaft of a vehicle to wipe a target surface to be wiped of the vehicle is provided. The wiper includes a wiper arm fixed to the pivot shaft. The wiper arm pivots when the pivot shaft operates. A wiper blade is connected to a distal end of the wiper arm. When the wiper arm pivots, the wiper blade pivots in a first wiping direction and a second wiping direction opposite to the first wiping direction, thereby wiping the target surface. The wiper blade defines an axis with respect to a lateral direction. A washer nozzle has an ejection hole through which a washer fluid is ejected onto the target surface. The washer nozzle is provided in at least one of the wiper arm and the wiper blade. The washer nozzle is arranged offset from the axis of the wiper blade in one of the first wiping direction and the second wiping direction. An ejecting direction of the washer fluid ejected from the ejection hole is set toward the axis of the wiper blade with respect to a line that extends parallel with the axis of the wiper blade and passes through the ejection hole.

According to another aspect of the invention, a wiper blade connected to a distal end of a wiper arm is provided. The wiper blade pivots in a first wiping direction and a second wiping direction opposite to the first wiping direction to wipe a target surface when the wiper arm pivots. The wiper blade includes a washer nozzle having an ejection hole through which a washer fluid is ejected onto the target surface. The washer nozzle is arranged offset from the axis of the wiper blade in one of the first wiping direction and the second wiping direction. An ejecting direction of the washer fluid ejected from the ejection hole is set toward the axis of the wiper blade with respect to a line that extends parallel with the axis of the wiper blade and passes through the ejection hole.

According to further aspect of the invention, a vehicle wiper secured to a pivot shaft of a vehicle to wipe a target surface to be wiped of the vehicle is provided. The target surface has a lateral end. The wiper includes a wiper arm fixed to the pivot shaft; a wiper blade connected to a distal end of the wiper arm; the wiper blade approaching the lateral end when moving in the first wiping direction; a blade rubber contacting the target surface to wipe the target surface; and a washer nozzle having an ejection hole. The washer nozzle is arranged offset from the blade rubber in the first wiping direction. An ejecting direction of the washer fluid ejected from the ejection hole is set toward the second wiping direction.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a front view illustrating a vehicle wiper according to one embodiment of the present invention, when installed in a vehicle;

FIG. 2A is a plan view showing the wiper shown in FIG. 1;

FIG. 2B is a partially enlarged view showing the wiper shown in FIG. 2A;

FIG. 3 is a cross-sectional view taken along line 3-3 of FIG. 2A;

FIG. 4 is a cross-sectional view taken along line 4-4 of FIG. 2A; and

FIG. 5 is a cross-sectional view showing a wiper blade of a modified embodiment.

### DETAILED DESCRIPTION OF THE PREFERRED EMBODIMENTS

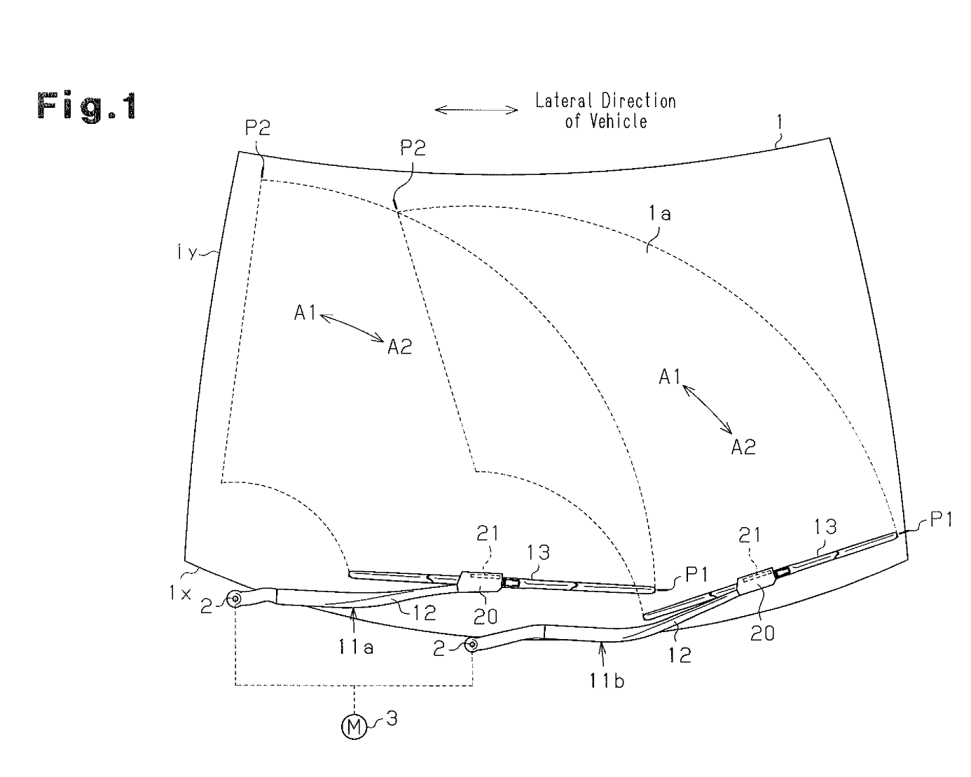

FIGS. 1 to 4 each show a first vehicle wiper 11a and a second vehicle wiper 11b according to one embodiment of the present invention.

As shown in FIG. 1, a vehicle has the first vehicle wiper 11a and the second vehicle wiper 11b, which wipe a windshield 1. The first vehicle wiper 11a and the second vehicle wiper 11b are each driven by a wiper motor 3 to pivot in such a manner as to wipe off dirt or rain drops on a target surface 1a of the windshield 1, which is to be wiped. The first vehicle wiper 11a and the second vehicle wiper 11b each include a wiper arm 12, a wiper blade 13, and an elongated blade rubber 15. The wiper arm 12 is secured to a pivot shaft 2 in such a manner that the wiper arm 12 and the pivot shaft 2 are allowed to pivot integrally. The wiper blade 13 is connected to the distal end of the wiper arm 12. The blade rubber 15 is held by the wiper blade 13. When the wiper motor 3 operates to pivot the pivot shaft 2, the wiper arm 12 and the wiper blade 13 also pivot. Specifically, the wiper blade 13 is allowed to pivot relatively with the wiper arm 12 in correspondence with the curved shape of the target surface 1a.

With reference to FIGS. 1 to 4, each of the wiper blades 13 has a lever assembly 14 and a cover assembly 16. The lever assembly 14 is connected to the wiper arm 12 and holds the blade rubber 15. The cover assembly 16 covers the lever assembly 14. The lever assembly 14 has a plurality of lever pieces that are connected together in tournament style. The cover assembly 16 is formed of rigid resin and covers the blade rubber 15 as a whole along the longitudinal direction. The cover assembly 16 has a central cover 16a and a pair of side covers 16b, which are arranged at opposite sides of the central cover 16a. Each of the side covers 16b is pivotally connected to the lever assembly 14.

The blade rubber 15 is held by a pair of backings 17, which extend in the longitudinal direction. The backings 17 disperse the pressing force applied to the blade rubber 15 by the lever assembly 14 to press the blade rubber 15 against the target surface 1a over the entire portion of the blade rubber 15.

The first vehicle wiper 11a and the second vehicle wiper 11b each include a first washer nozzle 21, a second washer nozzle 22, and a third washer nozzle 23, which eject washer fluid W onto the target surface 1a. The first to third washer nozzles 21 to 23 are supported by the associated wiper arm 12. The first nozzle 21 is a jet nozzle and ejects the washer fluid W in the form of a linearly concentrated jet stream. The second and third washer nozzles 22, 23 are diffusion nozzles and eject the washer fluid W such that the washer fluid W is diffused in the longitudinal direction of the wiper blade 13.

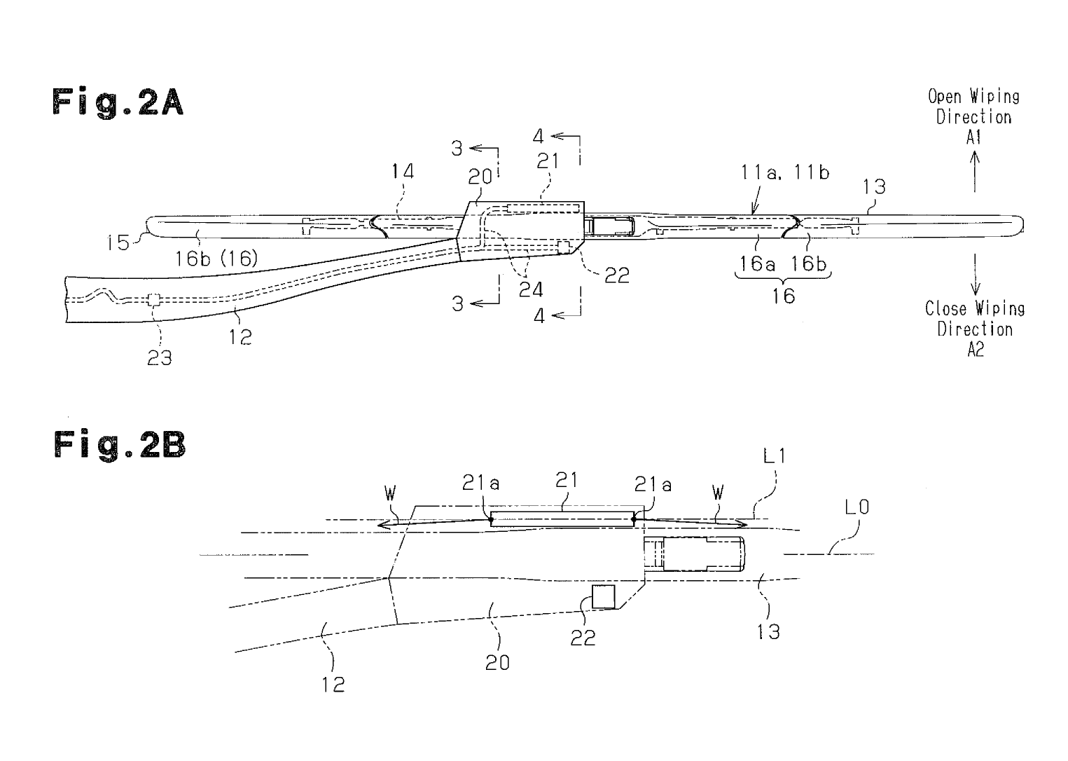

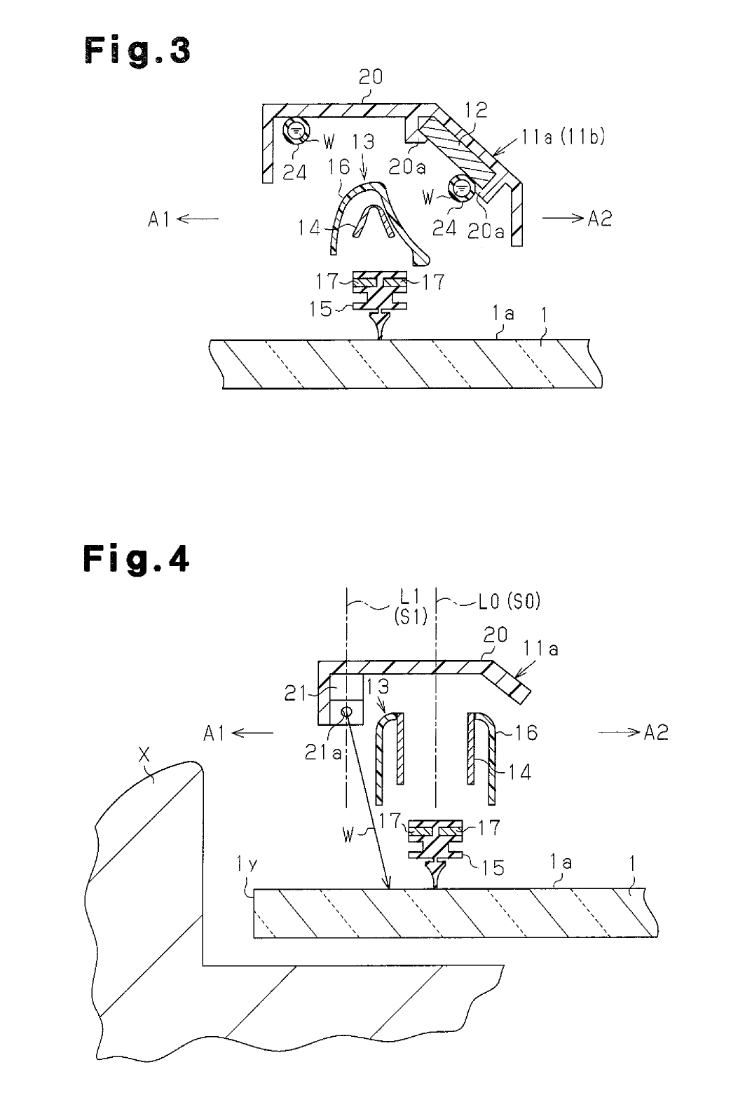

An attachment member 20 is detachably attached to the distal end of each wiper arm 12. The interior of the attachment member 20 incorporates the first and second washer nozzles 21, 22, thereby supporting the first and second washer nozzles 21, 22. In other words, the attachment member 20 functions also as a cover covering the first and second washer nozzles 21, 22. With reference to FIG. 3, the attachment member 20 has a pair of engagement pieces 20a, which are engaged with the lateral ends of the distal end of the wiper 15 arm 12. As illustrated in FIG. 2A, the first and second washer nozzles 21, 22 are arranged substantially at the longitudinal center of the wiper blade 13. The third washer nozzle 23 is located at the longitudinal center of the wiper arm 12. The first to third washer nozzles 21 to 23 receive the washer fluid W that is supplied under pressure from a washer tank (not shown) through a washer hose 24.

Each of the wiper blades 13 pivots between a lower reverse position P1 and an upper reverse position P2. This allows the associated one of the blade rubbers 15 to wipe the target surface 1a. The lower reverse position P1 serves also as a stop position of the wiper blade 13. When located at the lower reverse position P1, the wiper blade 13 is arranged at a lower end 1x of the windshield 1. In this state, the wiper blade 13 extends substantially parallel with the lateral direction of the vehicle and is held in a posture extending along the lateral direction of the vehicle. When arranged at the upper reverse position P2, the wiper blade 13 extends substantially perpendicular to the lateral direction of the vehicle and is maintained in a posture extending along a lateral end 1y of the windshield 1. In the following description, the direction from the lower reverse position P1 toward the upper reverse position P2 will be referred to as an open wiping direction A1, or a first wiping direction. In contrast, the direction from the upper reverse position P2 toward the lower reverse position P1 will be referred to as a close wiping direction A2, or a second wiping direction.

As shown in FIG. 2B, the wiper blade 13 defines a blade axis L0 extending in the longitudinal direction. The blade axis L0 is a lateral center line that extends through the lateral center of the wiper blade 13. The first washer nozzle 21 is arranged offset from the blade axis L0 in the open wiping direction A1. The second washer nozzle 22 and the third washer nozzle 23 are provided offset from the blade axis L0 in the close wiping direction A2. In other words, the first washer nozzle 21 is offset from the blade axis L0 in the advancing direction of the wiper blade 13 in open wiping and the second and third washer nozzles 22, 23 are offset from the blade axis Lo in the advancing direction of the wiper blade 13 in close wiping.

With reference to FIG. 4, the blade axis L0 is located on a central plane S0 that laterally divides the wiper blade 13 into two equal portions. The central plane S0 is indicated by the corresponding single-dotted chain line. When the blade rubber 15 is free from flexible deformation, the blade rubber 15 is caused to contact the target surface la along the central plane S0. In other words, the blade rubber 15 is set in such a manner as to contact the target surface 1a on the blade axis L0.

When the wiper blade 13 moves in the open wiping direction A1, or in the ascent of the wiper blade 13, the first washer nozzle 21 ejects the washer fluid W onto the wiping path of the wiper blade 13 prior to the wiping of the wiper blade 13. When the wiper blade 13 moves in the close wiping direction A2, or in the descent of the wiper blade 13, the second and third washer nozzles 22, 23 eject the washer fluid W onto the wiping path of the wiper blade 13 prior to the wiping of the wiper blade 13. In other words, the washer fluid W is supplied onto the wiping path of the wiper blade 13 prior to the wiping of the wiper blade 13. This allows the wiper blade 13 to smoothly wipe the target surface 1a.

As shown in FIG. 2B, the first washer nozzle 21 has a pair of ejection holes 21a, which are arranged at both ends of the first washer nozzle 21 in the direction corresponding to the blade axis L0. The ejection holes 21a eject the washer fluid W onto the two longitudinal ends of the blade rubber 15. The ejection holes 21a are both arranged on an eccentric line L1 extending parallel with the blade axis L0. The eccentric line L1 is offset from the blade axis L0 in the open wiping direction A1. With reference to FIGS. 2B and 4, the ejection holes 21a are set in such a manner as to eject the washer fluid W toward the inner side of the wiper blade 13 with respect to the eccentric line L1, or toward the blade axis L0 with respect to the eccentric line L1.

Specifically, as illustrated in FIG. 4, the eccentric line L1 is located on an eccentric plane S1, which extends parallel with the central plane S0 and is offset from the central plane S0 in the open wiping direction A1. The ejection holes 21a are located on the eccentric plane S1. Thus, the first washer nozzle 21 ejects the washer fluid W toward the blade axis L0 so that the washer fluid W is directed toward the vicinity of the blade rubber 15. Such ejection is illustrated in FIG. 2B, which is a plan view, and FIG. 4, which is a side view. In other words, the first washer nozzle 21 is offset from the blade rubber 15 in the open wiping direction A1. The ejecting direction of the washer fluid W ejected from each of the ejection holes 21a agrees with the close wiping direction A2.

As shown in FIG. 1, when located at the upper reverse position P2, the wiper blade 13 of the first vehicle wiper 11a is arranged close to the lateral end 1y of the windshield 1, or in the vicinity of a front pillar X of the body of the vehicle. With reference to FIG. 4, when the wiper blade 13 of the first vehicle wiper 11a moves in the open wiping direction A1, the first washer nozzle 21 ejects the washer fluid W toward the blade axis L0. This suppresses splash of the washer fluid W in a direction separating from the wiper blade 13. Thus, even when the wiper blade 13 is located in the vicinity of the front pillar X, the washer fluid W is prevented from splashing out of the lateral end 1y of the windshield 1 to the exterior.

The illustrated embodiment has the following advantages.

(1) The first washer nozzle 21 is arranged offset from the blade axis L0 in the open wiping direction A1. The ejecting direction of the washer fluid W ejected from each ejection hole 21a is set to a direction toward the blade axis L0 with respect to the eccentric line L1, which extends parallel with the blade axis L0 and passes through the ejection hole 21a. This suppresses splash of the washer fluid W ejected from the first washer nozzle 21 in a direction separating from the wiper blade 13. Thus, even when the first vehicle wiper 11a is arranged in the vicinity of the lateral end 1y of the windshield 1, overspray is suppressed and the washer fluid W is adequately supplied to the target surface 1a.

(2) The first washer nozzle 21 is arranged at the longitudinal center of each wiper blade 13. The ejecting directions of the washer fluid W ejected from the two ejection holes 21a are set to directions toward the two longitudinal ends of the wiper blade 13. This effectively distributes the washer fluid W along the blade axis L0 and over the entire length of the wiper blade 13.

(3) The first washer nozzle 21 is a jet nozzle and ejects the washer fluid W in a linearly concentrated manner, thus forming a jet stream. This creates directivity of the washer fluid W and prevents the washer fluid W from being influenced by relative wind. Accordingly, the washer fluid W is adequately ejected onto a target site on the target surface 1a and overspray is further reliably suppressed.

(4) The first washer nozzle 21 is arranged offset from the blade axis L0 in the open wiping direction A1. The second washer nozzle 23 and the third washer nozzle 23 are provided offset from the blade axis L0 in the close wiping direction A2. This arrangement supplies the washer fluid W to the target surface la prior to the wiping of the blade rubber 15 in both paths of the reciprocal wiping directions of the wiper blade 13. In this manner, the washer fluid W is quickly supplied to the target surface 1a by a sufficient amount.

The illustrated embodiment may be modified in the following forms.

The first washer nozzle 21 does not necessarily have to be a jet nozzle but may be changed to a diffusion nozzle. A diffusion nozzle is capable of supplying the washer fluid W to the target surface 1a in a diffused manner. Thus, as long as the first washer nozzle 21 diffuses the washer fluid W along the longitudinal direction of the wiper blade 13, the washer fluid W is supplied to the entire length the wiper blade 13, even if the number of the washer nozzles or the number of the ejection holes 21a are decreased.

Alternatively, the second and third washer nozzles 22, 23, which are diffusion nozzles, may be replaced by jet nozzles. Further, the first to third washer nozzles 21 to 23 may all be jet nozzles or, in contrast, diffusion nozzles.

The first to third washer nozzles 21 to 23 may be arranged at positions offset from the illustrated positions in the longitudinal direction of the associated wiper blade 13 as needed. If the first washer nozzle 21 and the second washer nozzle 22 are arranged offset from the longitudinal center of the wiper blade 13, the corresponding ejecting directions of the ejection holes 21a and the number of the ejection holes 21a must be altered as needed so that the washer fluid W is ejected onto the entire blade rubber 15.

Not all the first to third washer nozzles 21 to 23 are necessary. In other words, the third washer nozzle 23 provided in the wiper arm 12 may be omitted. Further, the second washer nozzle 22 may be omitted additionally to the third washer nozzle 23. However, the first washer nozzle 21 advantageously prevents overspray and ejects the washer fluid W prior to the wiping of the wiper blade 13 starting at the stop position, or the lower reverse position P1, to move in the open wiping direction A1. It is thus necessary to provide the first washer nozzle 21.

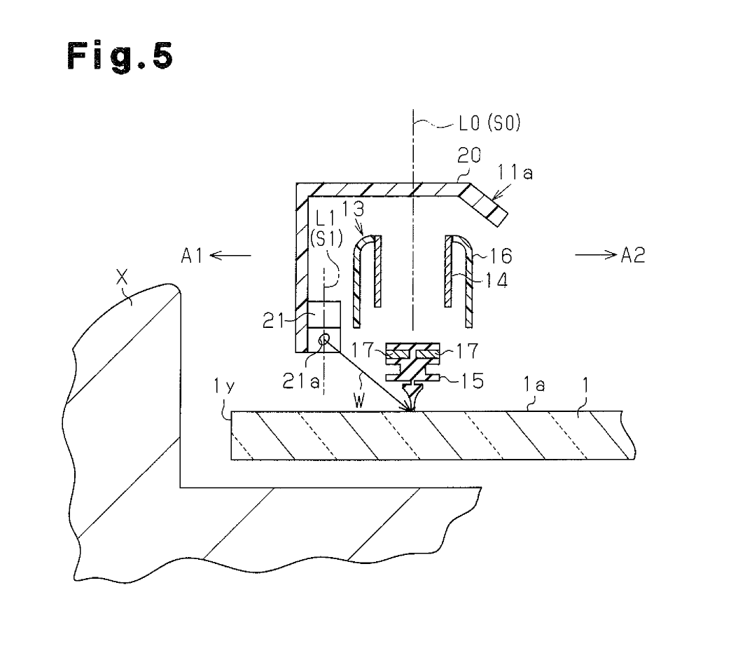

In the case illustrated in FIG. 4, the washer fluid W ejected from the first washer nozzle 21 is applied to the target surface 1a at a position slightly spaced from the associated blade rubber 15. However, as illustrated in FIG. 5, the orientation of each ejection hole 21a may be set in such a manner that the washer fluid W is applied directly onto the blade rubber 15 or onto a portion of the target surface 1a in the close proximity to the blade rubber 15. In the case illustrated in FIG. 5, the blade rubber 15 is further quickly wetted. This suppresses wear of the blade rubber 15 caused by friction between the blade rubber 15 in a dry state and the target surface 1a. Also, overspray is easily prevented from occurring.

Not all the first to third washer nozzles 21 to 23 have to be arranged in the wiper arm 12. That is, the first to third washer nozzles 21 to 23 may all be mounted in the wiper blade 13. Alternatively, the first to third washer nozzles 21 to 23 may be provided in a dispersed manner in the wiper arm 12 and the wiper blade 13.

In the illustrated embodiment, the lever assembly 14 having the multiple lever pieces holds the blade rubber 15 and the cover assembly 16 covers the lever assembly 14. However, the present invention is not restricted to this configuration. Specifically, the cover assembly 16 may be omitted or a lever member formed by a single component may support the blade rubber 15.

1. A vehicle wiper secured to a pivot shaft of a vehicle to wipe a target surface to be wiped of the vehicle, the wiper comprising:
a wiper arm fixed to the pivot shaft, the wiper arm pivoting when the pivot shaft operates;
a wiper blade connected to a distal end of the wiper arm, wherein, when the wiper arm pivots, the wiper blade pivots in a first wiping direction and a second wiping direction opposite to the first wiping direction, thereby wiping the target surface, the wiper blade defining an axis with respect to a lateral direction; and
a washer nozzle having an ejection hole through which a washer fluid is ejected onto the target surface, the washer nozzle being provided in at least one of the wiper arm and the wiper blade, the washer nozzle being arranged offset from the axis of the wiper blade in one of the first wiping direction and the second wiping direction, an ejecting direction of the washer fluid ejected from the ejection hole being set toward the axis of the wiper blade with respect to a line that extends parallel with the axis of the wiper blade and passes through the ejection hole.

2. The vehicle wiper according to claim 1, wherein the target surface has a lateral end,
wherein, when moving in the first wiping direction, the wiper blade approaches the lateral end, and wherein the washer nozzle is arranged offset from the axis of the wiper blade in the first wiping direction.

3. The vehicle wiper according to claim 1, wherein the washer nozzle is provided at the longitudinal center of the wiper blade, and
wherein the ejection hole is one of a plurality of ejection holes of the washer nozzle, the ejecting directions of the washer fluid ejected from the ejection holes are set toward at least two longitudinal ends of the wiper blade.

4. The vehicle wiper according to claim 1, wherein the wiper blade has a blade rubber that contacts the target surface to wipe the target surface, and
wherein the ejecting direction of the washer fluid ejected from the ejection hole is set toward the blade rubber.

5. The vehicle wiper according to claim 1, wherein the wiper blade pivots between a lower reverse position and an upper reverse position, the wiper blade extending in a lateral direction of the vehicle when located at the lower reverse position and extending along a lateral end of the target surface when arranged at the upper reverse position, and
wherein the ejection hole is arranged offset from the axis of the wiper blade toward the upper reverse position.

6. The vehicle wiper according to claim 5, wherein the washer nozzle is a jet nozzle, the washer fluid ejected from the ejection hole forming a linearly concentrated jet stream.

7. A wiper blade connected to a distal end of a wiper arm, the wiper blade pivoting in a first wiping direction and a second wiping direction opposite to the first wiping direction to wipe a target surface when the wiper arm pivots, the wiper blade defining an axis with respect to a lateral direction, wherein the wiper blade comprises:
a washer nozzle having an ejection hole through which a washer fluid is ejected onto the target surface, the washer nozzle being arranged offset from the axis of the wiper blade in one of the first wiping direction and the second wiping direction, an ejecting direction of the washer fluid ejected from the ejection hole being set toward the axis of the wiper blade with respect to a line that extends parallel with the axis of the wiper blade and passes through the ejection hole.

8. The wiper blade according to claim 7, wherein the target surface has a lateral end,
wherein, when moving in the first wiping direction, the wiper blade approaches the lateral end, and
wherein the washer nozzle is arranged offset from the axis of the wiper blade in the first wiping direction.

9. The wiper blade according to claim 7, wherein the washer nozzle is provided at the longitudinal center of the wiper blade, and
wherein the ejection hole is one of a plurality of ejection holes of the washer nozzle, the ejecting directions of the washer fluid ejected from the ejection holes being set toward at least two longitudinal ends of the wiper blade.

10. The wiper blade according to claim 7, further comprising a blade rubber that contacts the target surface to wipe the target surface,
wherein the ejecting direction of the washer fluid ejected from the ejection hole is set toward the blade rubber.

11. The wiper blade according to claim 7, wherein the wiper blade pivots between a lower reverse position and an upper reverse position, the wiper blade extending in a lateral direction of the vehicle when located at the lower reverse position and extending along a lateral end of the target surface when arranged at the upper reverse position, and
wherein the ejection hole is arranged offset from the axis of the wiper blade toward the upper reverse position.

12. The wiper blade according to claim 11, wherein the washer nozzle is a jet nozzle, the washer fluid ejected from the ejection hole forming a linearly concentrated jet stream.

13. A vehicle wiper secured to a pivot shaft of a vehicle to wipe a target surface to be wiped of the vehicle, the target surface having a lateral end, wherein the wiper comprises:
a wiper arm fixed to the pivot shaft, the wiper arm pivoting when the pivot shaft operates;
a wiper blade connected to a distal end of the wiper arm, wherein, when the wiper arm pivots, the wiper blade pivots in a first wiping direction and a second wiping direction opposite to the first wiping direction to wipe the target surface, the wiper blade approaching the lateral end when moving in the first wiping direction;
a blade rubber contacting the target surface to wipe the target surface; and
a washer nozzle having an ejection hole through which a washer fluid is ejected onto the target surface, the washer nozzle being provided in at least one of the wiper arm and the wiper blade, the washer nozzle being arranged offset from the blade rubber in the first wiping direction, an ejecting direction of the washer fluid ejected from the ejection hole being set toward the second wiping direction.
